(19) United States
(12) Patent Application Publication
(10) Pub. No.: US 2005/0126635 A1
(43) Pub. Date: Jun. 16, 2005

(54) Smart flow anomaly detector

(76) Inventors: Sylvan Addink, Riverside, CA (US); Paul Woodrum, Riverside, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 10/738,603

(22) Filed: Dec. 16, 2003

(51) Int. Cl. G05D 7/06

(52) U.S. Cl. 137/487.5

(57) ABSTRACT

The present invention provides a smart flow anomaly detector for a liquid distribution system comprising a flow measuring device that derives a liquid flow value for both automatically operated fixtures and manually operated fixtures. A microprocessor is in communication with the flow measuring device and is programmed to use the liquid flow value and a threshold liquid flow value to determine whether a flow anomaly exists. If a flow anomaly exists, the automatically operated fixtures and/or manually operated fixtures may be shut off and there after liquid flow to the automatically operated fixtures will be controlled based on a comparison of the liquid flow value attributed to the automatically operated fixtures and the threshold liquid flow value. Additionally, in a preferred embodiment of the present invention the microprocessor will generate a warning to alert the user when a flow anomaly occurs in the liquid distribution system.

### FIELD OF THE INVENTION

The field of the invention is water flow meters.

### BACKGROUND OF THE INVENTION

In arid areas of the world water is becoming one of the most precious natural resources. Meeting future water needs in these arid areas may require aggressive conservation measures. Each individual living or working in these arid areas should take the initiative to start conserving water. Most individuals are aware of some of the steps they can take to conserve water, such as installing low or ultra low flush toilets, installing water saving shower heads, sweeping rather than hosing off the driveway, irrigating the landscape efficiently and checking for leaks in the water system and irrigation system. However, with the last step, many individuals may not be aware of leaks in their water lines or irrigation systems.

Water system leaks can result in water waste of as high as 100 gallons per day. Various apparatus have been patented to detect leaks in water lines and irrigation systems. A leak detection device is discussed in U.S. Pat. No. 5,040,409 issued August 1991 to Kiewit. In Kiewit, an acoustic sensor and associated electronic circuitry are used to determine when a catastrophic leak occurs in an irrigation system. This apparatus would only detect catastrophic leaks and many leaks are not of a catastrophic nature but still may result in a substantial waste of water over an extended period of time.

A persisting problem with leak detection systems is that they are unable to differentiate between desired high use of water and undesired high use. Quite simply, in some cases, the water user desires to use a high quantity of water. Because they do not want the leak detection system to shut off the water when the user desires to use a high quantity of water, it is common practice for a water user to set the threshold value extremely high. Obviously, this practice may negate the use of the leak detection device. The following is a list of some patents that operate on the presumption that high use of water is undesired: U.S. Pat. No. 4,209,131 issued June 1980 to Barash et al., U.S. Pat. No. 4,705,060 issued November 1987 to Goulbourne, U.S. Pat. No. 5,004,014 issued April 1991 to Bender, U.S. Pat. No. 5,038,820 issued August 1991 to Ames et al., U.S. Pat. No. 5,139,044 issued August 1992 to Otten et al., U.S. Pat. No. 5,251,653 issued October 1993 to Tucker et al., U.S. Pat. No. 5,568,825 issued October 1996 to Faulk, U.S. Pat. No. 5,971,011 issued October 1999 to Price, and U.S. Pat. No. 6,216,727 issued April 2001 to Genova et al.

Some of the above patents, such as U.S. Pat. Nos. 5,251,653, 5,568,825 and 6,216,727 discuss the detection of leaks that would occur, when there would normally not be any water flowing. However, as with the other leak detection systems mentioned above, if the flow exceeds a certain set amount, either during or after a certain set amount of time is past, then the water will be shut off and/or a warning will be sent to the user. The drawback with all of these leak detection systems is that they do not take into consideration desired high use of water; people may take excessively long showers, newly planted landscaping may require excessive amounts of water, a pool may need to be filled up, and so forth.

What is needed is a leak detection system that can differentiate between desired high use of water and undesired high use. The present invention meets these requirements.

### SUMMARY OF THE INVENTION

The present invention is directed toward a smart flow anomaly detector for a liquid distribution system in which a flow measuring device derives a liquid flow value for both automatically operated fixtures and manually operated fixtures. A microprocessor, in communication with the flow measuring device, is programmed to use the liquid flow value and a threshold liquid flow value to determine whether a flow anomaly exists. If a flow anomaly exists, the automatically operated fixtures and/or manually operated fixtures may be shut off and thereafter liquid flow to the automatically operated fixtures will be controlled based on a comparison of the liquid flow value attributed to the automatically operated fixtures and the threshold liquid flow value.

The automatically operated fixture may be an irrigation system, a fountain, or any commercial, industrial, agricultural (and so forth) fixture into which, or through which, liquid flows. An automatically operated fixture is setup to be operated automatically in that it does not require a manual operation by a user to be actuated (i.e. for liquid to flow).

The manually operated fixture may be a shower, a toilet, a clothes washer, or any commercial, industrial, agricultural (and so forth) fixture into which, or through which, liquid flows. A manually operated fixture is one that is setup to be operated by manually in that it requires a manual operation by a user to be actuated (i.e. for liquid to flow).

There are of course, fixtures that are setup to operated manually or automatically. Whether a particular fixture is designated a manual fixture or an automatic fixture generally depends upon whether the fixture has been actuated by a manual action (by a human) or by an automated action.

Typically, a liquid flow value is determined and this value represents total liquid flow to both automatically and manually operated fixtures. A flow anomaly exists if the liquid flow value exceeds the threshold liquid flow value by a certain amount. This certain amount is usually pre-set and may be input by a user of the smart flow leak detection system. The source of a flow anomaly may be a leak caused by a broken pipe, a valve that won't close, or any other condition which causes waste of the liquid that flows through the liquid distribution system.

In a preferred embodiment of the present invention, liquid pressure, corresponding to the flow of the liquid, will be measured. Since a change in liquid pressure effects the liquid flow rate, the liquid pressure data will provide additional information to improve the efficiency of the flow anomaly detector. Additionally, in a preferred embodiment of the present invention, the microprocessor will generate a warning to alert individuals, when a flow anomaly occurs in the liquid distribution system.

The microprocessor may be disposed in an irrigation controller or any other device that uses a microprocessor in its operation. However, it can be appreciated that the microprocessor may be housed as a separate unit that is dedicated to detecting flow anomalies in liquid distribution systems.

In a preferred embodiment of the present invention, only one meter (e.g. flow meter) is required to provide flow data that is used in the method according to the present invention. The one meter will be used to monitor liquid distribution systems both inside and outside the residence, business or other liquid distribution site.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a block diagram of a flow anomaly detector for a liquid distribution system.

FIG. 2 is a schematic of a flow anomaly detector.

FIG. 3 is a flow chart of steps involved in a method for detecting flow anomalies in a liquid distribution system.

### DETAILED DESCRIPTION

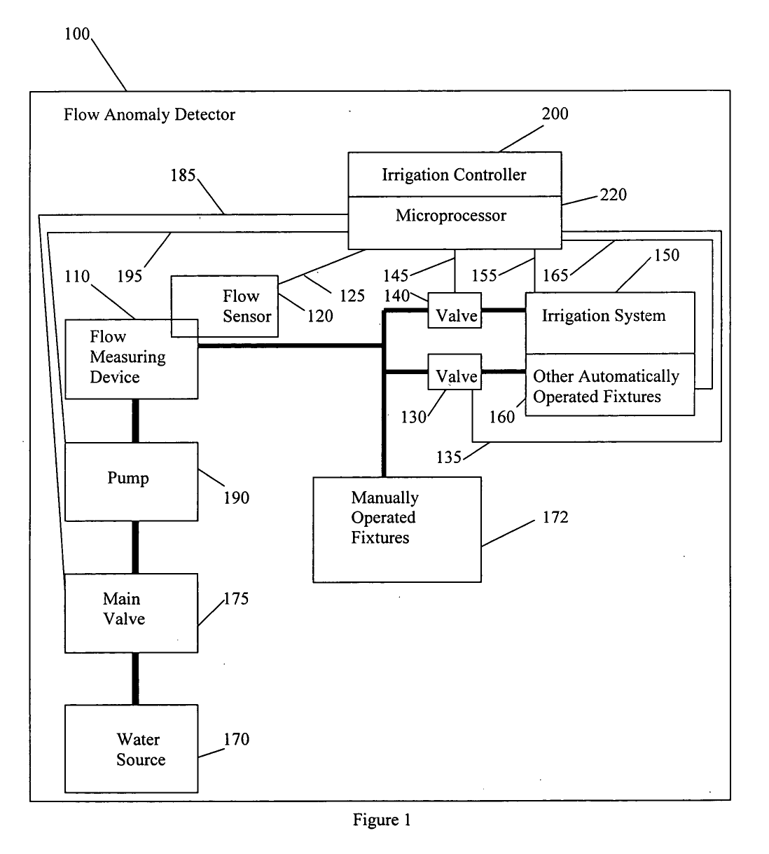

FIG. 1 is an example of a flow anomaly detector 100 for a liquid distribution system according to the present invention. In this example the liquid distribution system is a water distribution system, however it can be appreciated that the liquid distribution system can be composed of any material capable of flowing including substances other than water. The flow measuring device 110 derives a liquid flow value of the water. The flow sensor 120 transmits a signal over channel 125 that is proportionate to the liquid flow value of the liquid, to the microprocessor 220, where the signal may be converted into appropriate units of liquid flow measurement. The microprocessor 220, in this example, is disposed in an irrigation controller 200. However, it can be appreciated that the microprocessor 220 may be disposed in any other device or even be disposed in it's own separate housing, where it is dedicated to perform flow anomaly detection functions. The irrigation controller 200 may be an automatic irrigation controller, a manual input controller, a personal computer or any other device that provides control of an irrigation system 150. Among other things, the controller 200 starts the pump 190 (not used with every irrigation system) and operates solenoids (not shown), which open the valve 140 to allow irrigation water to flow from the water source 170 to be applied to the landscape through the irrigation system 150. The flow measuring device 110 is preferably positioned between the pump 190 (the water source 170, if no pump is present) and the valve 140. However, it is contemplated that the flow measuring device 110 may be positioned after the valve 140 but before the sprinklers (not shown) in certain situations.

The liquid distribution system may be located at a residential site, a commercial site, an industrial site, an agricultural site or any other site where liquid (flow) distribution systems might be located.

Although in this example, the only automatically operated fixture listed is an irrigation system 150, it can be appreciated that other automatically operated fixtures 160 may also be located at the site and be a part of the liquid distribution system. These other automatically operated fixtures 160 may be fountains, waterfalls, automatic industrial processes that use water and so forth. Although, one valve could control the liquid distributed to all automatically operated fixtures, in a preferred embodiment of the present invention there would be a separate valve 130 and 140 to each of the automatically operated fixtures or at least to each of the major automatically operated fixtures that use a substantial quantity of liquid. As defined herein, an automatically operated fixture is any fixture that is connected to the liquid distribution system and that is actuated automatically (i.e. is not manually actuated). It should be recognized that an automatic fixture may also be operated manually, under certain situations.

As defined herein, a manually operated fixture is any fixture that is actuated manually. It is not contemplated that there will be a separate valve to control the flow of the liquid to the manually operated fixtures 172. However, it can be appreciated that in some situations it may be desirable to also have a valve to control the liquid to the manually operated fixtures as well as to the automatically operated fixtures.

With most liquid distribution systems there will be a main valve 175 that will control the flow of the liquid to the entire site. Preferably the main valve 175 is located before the flow measuring device 110 but it can also be located after the flow meter but before any automatically operated fixtures 150-160 and manually operated fixtures 172.

The microprocessor 220 is connected to the various devices of the flow anomaly detector 100 via either wired or wireless means over communication channels 125, 135, 145, 155, 165, 185 and 195. In a preferred embodiment of the present invention, the microprocessor receives data from the various devices directly. As used herein, the term “directly” means that there is no third device between the sending and receiving devices. However, the microprocessor may receive the data by other means that does not require a direct connection between the microprocessor and the various devices, such as by radio, pager and telephone.

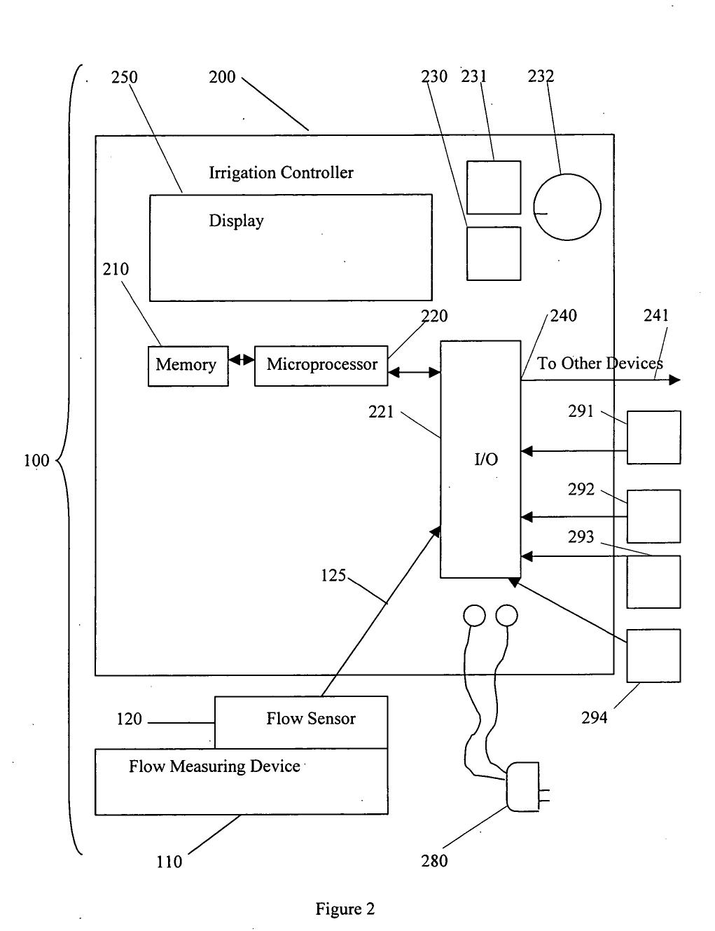

FIG. 2 is a schematic of a flow anomaly detector 100 according to an aspect of the present invention that includes a flow measuring device 110, a flow sensor 120 that is connected over path 125 to the microprocessor 220 through an input/output (I/O) circuitry 221 that is connected in a conventional manner, an on-board memory 210, some manual input devices 230 through 232 (buttons and/or knobs), a display screen 250, a communications port 240, a serial, parallel or other communications connection 241 coupling the irrigation controller 200 to other devices, such as personal computers, telephone lines, radio transmitters, etc., a power supply 280, a rain detection device 291, a wind sensor 292, a water pressure sensor 293 and a temperature sensor 294. Each component by itself is well known in the electronic industry, with the exception of the programming of the microprocessor in accordance with the functionality set forth herein. There are hundreds of suitable chips that can be used for this purpose. At present, experimental versions have been made using a generic Intel 80C54 chip, and it is contemplated that such a chip would be satisfactory for production models.

In a preferred embodiment of the present invention the irrigation controller has one or more common communication internal bus(es). The bus can use a common or custom protocol to communicate between devices. There are several suitable communication protocols, which can be used for this purpose. At present, experimental versions have been made using an I²C serial data communication, and it is contemplated that this communication method would be satisfactory for production models. This bus is used for internal data transfer to and from the EEPROM memory, and is used for communication with peripheral devices and measurement equipment including but not limited to a flow sensor 120, a rain detection device 291, a wind sensor 292, water pressure sensor 293, and a temperature sensor 294.

The power supply 280 can be electricity, battery, solar, or any other suitable power supply.

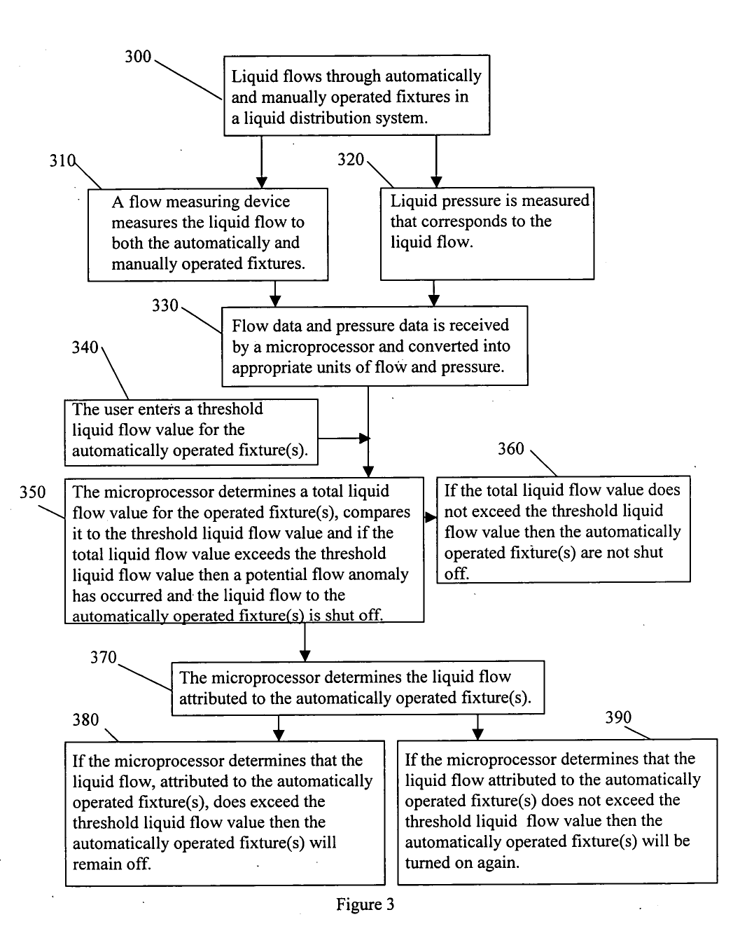

In FIG. 3, the first step in a method of determining whether there is a flow anomaly in a liquid distribution system is that the automatically and/or manually operated fixtures are turned on and the liquid flows into or through the fixture 300. The flow measuring device is activated by the flow of liquid through the pipe 310. The flow measuring device measures the flow of the liquid to both the automatically operated fixture and any manually operated fixtures that are turned on. In a preferred embodiment of the present invention, the flow measuring device may be a single water meter that is installed during original construction at the site. The site may be a residential, commercial, industrial, agricultural or any other type of site. In certain situations, for example where there are multiple automatically operated fixtures at a site, it may be advantageous to install a separate flow measuring device for each of the automatically operated fixtures. The flow measuring device may comprise a propeller flow meter, an ultra sonic flow meter, an impeller type flow meter, or other suitable type of flow measuring device. With most flow measuring devices, a flow sensor (See FIG. 2, 120) detects the flow of the liquid through the flow measuring device and a signal, in proportion to the flow, is transmitted to the microprocessor 220 via an input/output device 221. With some flow measuring devices, such as with a propeller flow meter, the flow sensor 120 detects the revolving of the propeller and a signal, in proportion to the revolutions sensed, is transmitted to the microprocessor 220 via an input/output device 221.

Referring again to FIG. 3, step 320, a change in liquid pressure will effect the liquid flow rate. Liquid pressure data is taken into consideration in the determination, by the microprocessor, as to whether the liquid flow has exceeded a threshold liquid flow value or not. As the pressure changes the flow rate also changes, therefore, in a preferred embodiment of the present invention the microprocessor will vary the threshold liquid flow value to take into consideration changes in the liquid pressure. In step 330, the flow data and pressure data are received by a microprocessor and converted into appropriate units of flow and pressure. The units of liquid flow may be gallons per minute, acre inches, acre feet or any other suitable liquid flow measurement unit. The units of liquid pressure may be pounds per square inch or any other suitable liquid pressure measurement unit.

The user may enter into the microprocessor a threshold liquid flow value for the automatically operated fixtures 340. As used herein, the term “user” may include any entity having an interest in efficient liquid distribution in a liquid distribution system. In addition to the owner, this may include the operator, water district personnel, and so forth. It is contemplated that the threshold liquid flow value will be a value that will be only slightly above the maximum liquid flow that is determined by the user to flow into or thru the automatically operated fixtures. In a preferred embodiment of the present invention there is a separate threshold liquid flow value determined for each automatically operated fixture in the liquid distribution system and if the liquid flow to more than one automatically operated fixture is measured by one flow measuring device then the threshold liquid flow value would be equal to the combined threshold liquid flow value of the two automatically operated fixtures. It can be appreciated that it may be desirable to have the flow to two or more automatically operated fixtures measured by the same flow measuring device to save on the costs of installing separate flow measuring devices and valves to each automatically operated fixture. However, in certain situations, it may be advantageous to have separate flow measuring devices and valves installed for each automatically operated fixture. This will allow the microprocessor to shut off each automatically operated fixture independently of the other, should the microprocessor determine a flow anomaly has occurred with one of the automatically operated fixtures and not the other automatically operated fixture.

Referring again to FIG. 3, in step 350 the microprocessor determines a total liquid flow value, for the operated fixture(s), including both automatically operated fixtures and manually operated fixtures. The microprocessor then compares the total liquid flow value, for the operated fixture(s), to the threshold liquid flow value for the automatically operated fixture(s) and if the total liquid flow value exceeds the threshold liquid flow value then a potential flow anomaly may have occurred and the liquid flow to the automatically operated fixture(s) is shut off, step 350. If the total liquid flow value does not exceed the threshold liquid flow value, then the automatically operated fixture(s) are not shut off, step 360.

In step 350, the microprocessor determined there was a potential flow anomaly because the total liquid flow value of both the automatically operated fixtures and manually operated fixtures exceeded the threshold liquid flow value for the automatically operated fixture(s). However, if someone had manually turned on a fixture, the flow measuring device was measuring the liquid flow to the manually operated fixture as well as the flow of the automatically operated fixture, which could be the reason that the total liquid flow value exceeded the threshold liquid flow value for the automatically operated fixture. Therefore, by turning off the automatically operated fixture the microprocessor can determine whether there are some manually operated fixtures that are on and determine the flow of liquid that is attributed to the manually operated fixture. The microprocessor then deducts the flow attributed to the manually operated fixtures from the total liquid flow value to arrive at the liquid flow attributed to the automatically operated fixture(s), step 370. If the liquid flow, attributed to the automatically operated fixture(s), exceeds the threshold liquid flow value for that automatically operated fixture, the microprocessor determines that a flow anomaly exists and the microprocessor will cause the automatically operated fixture to remain in the off position, step 380.

The term ‘flow anomaly’ as used herein, generally refers to a liquid flow of an automatically operated fixture that exceeds the threshold liquid flow value that was entered by the user into the microprocessor for the same automatically operated fixture. The flow anomaly could be due to a leak in the automatically operated fixture, such as with an irrigation system, it may be a broken pipe, a broken sprinkler head, or any other break that may be present in the liquid distribution portion of the irrigation system. It is also possible that the flow anomaly is due to a valve that did not close. Generally, with most residential irrigation system, only one station or valve is on at a time. After the area of the landscape serviced by the station or valve is watered for the appropriate period of time the valve closes and the next station or valve turns on. However, if the previous valve, which was suppose to close, is stuck open and does not close the water will continue to flow to that section of the irrigation system as well as to the area of the irrigation system where the subsequent valve was activated. This will likely result in the determination, by the microprocessor, that the water flow to the automatically operated fixture (irrigation system) exceeds the threshold water flow value that was entered by the user for the irrigation system. It is therefore contemplated that the microprocessor will maintain the valve that was closed when the microprocessor determined there was a potential flow anomaly to remain in the closed position so no water will be allowed to flow to the irrigation system.

In the previous paragraph, flow anomalies are exemplified in a leak and a stuck valve. However, it can be appreciated that there can be flow anomalies that are caused by factors other than leaks or stuck valves in a liquid distribution system. In a preferred embodiment of the present invention, any factor that would cause the flow of a liquid, into or through an automatically operated fixture(s) to be in excess of the threshold liquid flow value for that automatically operated fixture(s), would be considered a flow anomaly. Additionally, it is anticipated that corrective steps would be taken to determine what factors, in the liquid distribution system, contributed to the flow anomaly and then corrective steps taken to correct the problem.

If the microprocessor determines that the liquid flow attributed to the automatically operated fixture(s) does not exceed the threshold liquid flow value then the automatically operated fixture(s) will be turned on again, step 390 (or remain on if they have not been previously turned off).

In a preferred embodiment of the present invention, information on the flow anomaly will be provided to the user. It is contemplated that this would be accomplished by a flashing display, a warning or other means that would get the attention of the user. The warning may be through any suitable means, including, for example, an audible alarm, an alarm mechanism, and other warning means.

The information on the flow anomaly may be displayed as a ratio, a difference, a graph, actual values of liquid flow of the automatically operated fixture(s) and the threshold liquid flow value or any other suitable form that aids the user toward taking appropriate action to correct the flow anomaly and/or prevent the flow anomaly from occurring in the future.

Thus, specific embodiments and applications of methods and apparatus of the present invention have been disclosed. It should be apparent, however, to those skilled in the art that many more modifications besides those described are possible without departing from the inventive concepts herein. The inventive subject matter, therefore, is not to be restricted except in the spirit of the appended claims.

1. A smart flow anomaly detector for a liquid distribution system, comprising:
a flow measuring device that derives a liquid flow value for both automatically operated fixtures and manually operated fixtures; and
a microprocessor, in communication with the flow measuring device, programmed to use the liquid flow value and a threshold liquid flow value to determine whether a flow anomaly exists and if the flow anomaly exists, to:
shut off liquid flow to one of the automatically operated fixture and the manually operated fixture; and
control liquid flow to the automatically operated fixture based on a comparison of a liquid flow value attributed to the automatically operated fixture and the threshold liquid flow value.

2. The flow anomaly detector of claim 1, wherein the automatically operated fixture is an irrigation system.

3. The flow anomaly detector of claim 1, wherein the manually operated fixture is a shower.

4. The flow anomaly detector of claim 1, wherein the flow anomaly is associated with a leak.

5. The flow anomaly detector of claim 1, wherein the flow anomaly is associated with a valve stuck open.

6. The flow anomaly detector of claim 1, wherein the flow measuring device is configured to measure liquid pressure corresponding to the liquid flow value.

7. The flow anomaly detector of claim 1, wherein the microprocessor is programmed to generate a warning when the flow anomaly exists.

8. A method for detecting flow anomalies in a liquid distribution system, comprising:
deriving a liquid flow value to both automatically operated fixtures and manually operated fixtures with a flow measuring device;
comparing the liquid flow value to a threshold liquid flow value and upon detection of a flow anomaly:
shutting off liquid flow to the automatically operated fixture; and
controlling subsequent liquid flow to the automatically operated fixture based on a comparison of the liquid flow attributed to the automatically operated fixture and the threshold liquid flow value for that automatically operated fixture.

9. The method of claim 8, wherein the automatically operated fixture is an irrigation system.

10. The method of claim 8, wherein the manually operated fixture is a shower.

11. The method of claim 8, wherein the flow anomaly is associated with a leak.

12. The method of claim 8, wherein the flow anomaly is associated with a valve stuck open.

13. The method of claim 8, further comprising a step of measuring liquid pressure corresponding to the liquid flow.

14. The method of claim 8, further comprising a step of generating a warning to alert a user when a flow anomaly occurs with the liquid distribution system.
